(19) United States
(12) Patent Application Publication
(10) Pub. No.: US 2008/0092447 A1
(43) Pub. Date: Apr. 24, 2008

(54) Door Drive Mechanism, Especially Revolving Door Drive Mechanism

(75) Inventor: Volker Bienek, Dortmund (DE)

Correspondence Address: COHEN, PONTANI, LIEBERMAN & PAVANE, 551 FIFTH AVENUE, SUITE 1210, NEW YORK, NY, 10176, US

(73) Assignee: DORMA GMBH + CO. KG, Ennepetal (DE)

(21) Appl. No.: 11/793,218

(22) PCT Filed: Nov. 14, 2005
(86) PCT No.: PCT/EP05/12166

§ 371 Date: Jun. 18, 2007

(30) Foreign Application Priority Data
Dec. 17, 2004 (DE) 10 2004 061 630.2

(51) Int. Cl. E05F 15/04; E05F 3/10

(52) U.S. Cl. 49/340

(57) ABSTRACT

A door operator includes a housing; first and second pressure compartments; an unpressurized reservoir chamber; a drive unit disposed in the housing and coupleable to a door via an output shaft, the drive unit being associated with the first pressure compartment; a hydraulic pump in hydraulic connection with the first and second pressure compartments; a motor in driving relationship with the hydraulic pump; a spring force accumulator disposed in the housing, the spring force accumulator being associated with the second pressure compartment and coupled to the drive unit; a hydraulic circuit connecting at least one of the first and second pressure compartments with the hydraulic pump; and a fire-protection/releasing device disposed between the hydraulic circuit and the unpressurized reservoir chamber.

The invention relates to a door operator, in particular a swing door operator according to the generic part of patent claim 1.

Such a door operator is known from DE 295 21 068 U1. An overhead door closer with a slide rail linkage is known from DE 40 38 720 C2, which has a cam drive unit allowing for an optimum door moment curve and a comfortable operation. In principle this overhead door closer would thus be suitable as door operator as well; however, experiments conducted during the course of the invention have shown that applying oil pressure to the drive unit results in a very unfavourable transformation of the hydraulic pressure into the resulting movements of stroke/rotation and repeated stroke. Since about 75% of the output capacity to be applied is required for loading the spring force accumulator of such a door closer, whereas only about 25% of the output capacity needs to be delivered by the system for accelerating the door. As it is furthermore desirable to keep the narrow structure of such a door closer for door operators as well, the dimensions of the structural components can hardly be adapted to the extremely high loads. Thus, although functionally and technically advantageous, the known overhead door closer is not suitable as a door operator.

Another swing door operator is known from DE 197 56 496 C2. This swing door operator has an electromechanical drive unit, which is provided with a drive motor and a gear and with a subsequent power transmission unit for the connected door. The power transmission unit has a spindle with a spindle nut partially overlapping the former, which spindle is non-positively and positively connected to a toothed rack. Although this swing door operator can be installed concealed, the door moment curve is not as optimal as with the above described door closers having the cam technology. Moreover on account of the larger construction width, installation in standard profiles is not possible.

Therefore, it is the object of the present invention to provide a door operator of the species indicated in the generic part of patent claim 1, which can be installed completely concealed within the door profile or frame profile, and also be mounted on the door and does not require any special constructions of the door system.

The solution of the problem is achieved by the features of patent claim 1.

On account of its compact structure, the inventive door operator allows for a concealed installation within a door profile or a frame profile and thus allows for a total integration with the door system.

Particularly, the installation in common narrow door profiles is possible.

As an advantage, neither special door profiles nor any special constructions, which would interfere with the design of the door system, are necessary. Another advantage results from an economical mounting combined with a wide applicability and, moreover, it is possible to retrofit existing door systems with the inventive door operator. Another advantage results from the fact that, in the inventive door operator, a direct introduction of power for loading a spring force accumulator is possible. Therefore, the possibility is given of avoiding unnecessarily stressing the mechanical structural components and of lowering the required operating pressure, because larger effective piston areas are provided. This construction results furthermore in the advantage of having a larger stroke volume, thus improving the operational range for common hydraulic pumps.

As the hydraulic pump of the inventive door operator is in hydraulic connection with a separate pressure compartment, which is associated directly to the spring force accumulator, a direct pressure application and thus a direct introduction of power into the spring force accumulator is the result, whereby the pre-loading of the spring force accumulator is completely or at least partially achieved. By this measure, the disadvantages explained at the beginning are completely eliminated.

As the output capacity, to be delivered for opening a door, in particular a swing door, with a door operator which is provided with the spring force accumulator for the closing operation and for fire-rated suitability, is divided into two magnitudes of force or torque, it is advantageous with the inventive door operator that, by assigning separate pressure compartments to the drive unit and to the spring force accumulator, a lower oil pressure can be applied to the drive unit, because the torque, required for opening and accelerating the door, is lower at the output shaft of the drive unit than the one for pre-loading the spring force accumulator.

Experiments conducted during the course of the invention have shown that, depending on the size of the door and the weight of the door, as a rough approximation about ⅔ to ¾ of the total drive power is required for pre-loading the spring force accumulator, whereas only about ¼ to ⅓ of the total power is required as drive moment for opening the door.

As, in the inventive door operator, dividing this total output capacity is made possible by providing separate pressure compartments, a direct pressurizing of the spring force accumulator is achieved, and it is thus possible to directly utilize the major part of the total output capacity, without redirection, for pre-loading the spring force accumulator. Therefore, unnecessary stress on structural components, load on bearings, and any loss on account of friction or loss of efficiency are avoided. On account of the separate pressure compartment associated to the spring force accumulator, the effective piston areas for loading the spring force accumulator are further increased, and the required system pressure is thus considerably lowered and the stroke volume increased. As a consequence, the control response (during the closing operation) is improved and the overall hydraulic system becomes less sensitive.

Furthermore, on account of the higher volume flow/lower pressure ratio, a small sized hydraulic pump can be used, enabling the pump characteristics to be considerably flatter, making the pump simpler from the technical point of view, and less expensive. Furthermore, it is preferably possible to use pressure control valves or pressure limiting valves in the feeding lines or to use different hydraulic pumps for the respective pressure compartments such that, if required, a division and adaptation of the piston forces of the damping, spring loading, and/or opening pistons, is possible.

It can thus be achieved that the torque, required at the output shaft for opening the doors, can be generated by means of a damping piston and a cam arrangement, whereas the spring loading work is generated independently therefrom in the additional separate pressure compartment.

Furthermore, according to the invention, the door operator has associated a motor, preferably in the shape of a direct current or an alternating current motor, and an assembly of pumps, which delivers the necessary oil volume in addition to the required pressure in the one or more operating chambers of the door operator. As already explained above, the spring force accumulator is thus loaded and, via the drive mechanism, a torque is generated for accelerating the door.

In this case, according to the invention, the hydraulic pump pushes the hydraulic oil leak-free by means of a proportional piston from one compression chamber into the operating chamber or chambers (pressure compartments) of the door operator. The stroke volumes of the compression chamber of the pumps and of the operating chamber or chambers of the door operator are suitably coordinated in this case.

The volume in the operating chamber or chambers, corresponding to the door opening angle, is practically moved out of the compression chamber of the pumps only. Therefore, hold-open and arresting functions are easy to realize. Also the opening speed is very well controllable.

Furthermore, according to the invention, a fire-protection/releasing device is provided such that the inventive door operator can be utilized also for fire-rated doors. The fire-protection/releasing device is provided in order to compensate for the self-locking of the spindle of the hydraulic pump, because otherwise, in the event of power failure, the door would not be able to close on account of the lack of oil flow.

The releasing device is disposed between the operating hydraulic circuit of the door operator and an unpressurized reservoir chamber of the housing of the door operator.

Preferably, the releasing device is formed in the shape of a solenoid valve, which operates according to the closed-circuit principle and is only closed when its electromagnet is energized. If no voltage is applied, a return spring pushes the solenoid valve in an open position.

Interrupting the supply voltage is performed for example by smoke detectors, fire alarm systems, manual push-buttons or only by power failure.

The oil volume in the operating chambers or pressure compartments of the door operator can thus flow into the reservoir chamber and, through the action of the spring force accumulator on the door closer mechanism, in each case the door can be closed automatically.

The pump spindle including the associated proportional piston, which remain in the open position in such a case, will be returned to their initial position by the control of the inventive door operator, once the regular operating conditions are re-established.

Prior to an opening operation, the solenoid valve will be closed by the control of the drive in order to build up pressure in the operating hydraulic circuit of the door operator.

This results in the additional advantage that the inventive door operator is suitable for fire-rated doors as well.

Thus, the inventive door operator is characterized by the following advantages. An inexpensive pump can be utilized, because the pump set-up is simple. The pump allows for a leak-free embodiment and has a low-noise operation. Furthermore, a completely variable, controllable opening course and closing course are made possible. The inventive door operator is suitable for the smallest stroke volumes and high pressures and it is optimal for arresting functions and hold-open constructions.

The dependent claims feature advantageous further developments of the invention.

Further details, features and advantages of the invention will become apparent from the following description of a preferred embodiment example, reference being made to the drawing.

The only FIGURE of the drawing 1 shows an inventive door operator 1, which in particular may be executed as a swing door operator. The door operator 1 has a drive unit 2, which, via an output shaft 9, can be coupled to a door, not illustrated in the FIGURE, for example via a lever and a slide channel with a sliding member. The drive unit 2 is disposed in a housing 13.

Furthermore, the door operator 1 has a motor 3 as well as, disposed in the housing 13, a spring force accumulator 4, which is coupled to the motor 3 and to the drive unit 2.

As depicted in the FIGURE, the motor 3 is in driving connection with a hydraulic pump 5. In the illustrated embodiment, the motor 3 and the pump 5 are flange-mounted to the housing 13. However, the motor 3 and the pump 5 may be disposed separately or they may be integral with the housing. The motor 3, via the hydraulic pump 5 and a first hydraulic line 22, is in hydraulic connection with a pressure compartment 7, which is associated to the spring force accumulator 4. Via a second hydraulic line 23, the motor 3 and the pump 5 are in hydraulic connection with a pressure compartment 6, which is associated to the drive unit 2. This disposition allows to divide the required pressures or forces for opening the door and for loading the spring force accumulator 4, which in the exemplary case has a compression spring 12, resulting in the advantages explained at the beginning.

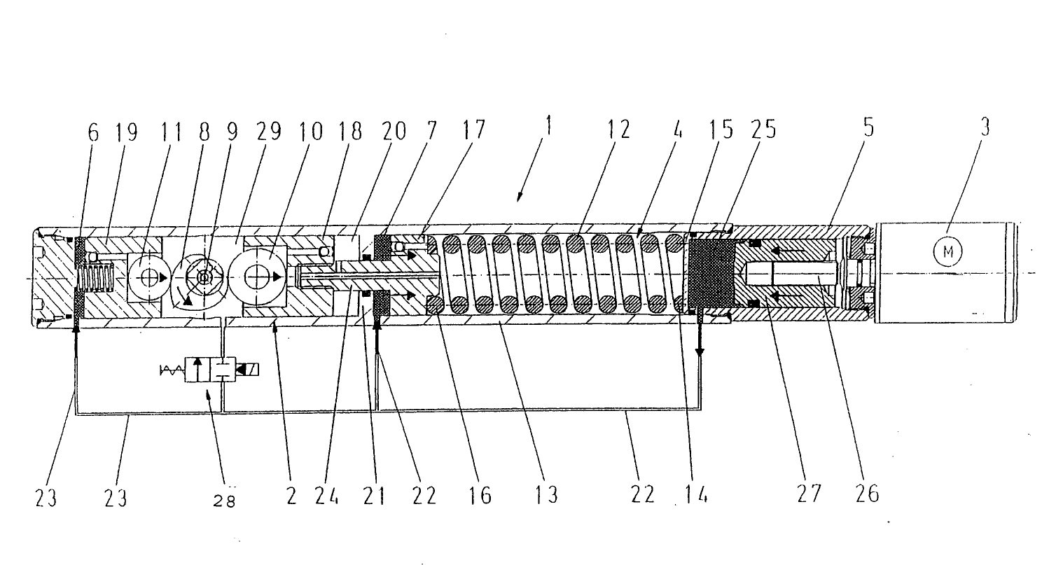

In the embodiment illustrated in FIG. 1, the drive unit 2 is formed as a cam drive. This cam drive has a cam disc 8, which is disposed on the output shaft 9. The cam disc 8 cooperates with two force transmission rollers 10 and 11, which are disposed on both sides of the output shaft 9 and bear on cam paths of the cam disc 8. This structure corresponds in principle to the structure of the overhead door closer of DE 40 38 720 C2, the content thereof being incorporated herein as disclosure content of the present application.

The force transmission roller 11 is disposed at a damping piston 19, which is supported in the housing 13 adjacent the pressure compartment 6.

The force transmission roller 10 is disposed at an opening piston 18, which is likewise supported in the housing 13 and adjoins a compartment 20, which is separated from the separate pressure compartment 7 via a separating wall 21.

As revealed in FIG. 1, a spring loading piston 17, which directly introduces the force for loading the compression spring 12 into the latter, is disposed in the pressure compartment 7. The spring loading piston 17 is connected to the opening piston 18 via a piston rod 24, which is passes in a sealed manner through the separating wall 21.

Furthermore, FIG. 1 shows that one end 14 of the spring 12 bears against a housing wall 15 of the pump 5, whereas its other end 16 bears against the spring loading piston 17.

As revealed in FIG. 1, this division into pressure compartments first of all results in the option, preferably through suitable hydraulic control means (solenoid valves, throttles, or the like), to realize a division of the required pressures for loading the compression spring 12 and for opening the door, and to exploit at the same time the advantages of the cam technology. A further result is the extremely compact design, as explained at the beginning, which allows for a completely concealed installation in door profiles or frame profiles.

As FIG. 1 shows furthermore, the pump 5 has a proportional piston 27, which is moved translationally by means of a spindle 26. The spindle 26 may be provided with thread pitches or executed as a recirculating ball screw. The motor 3, with or without upstream gear, drives the spindle 26 itself. Preferably, a gear is utilized, because of the relatively high torque and for reasons of positioning accuracy. Preferably a spindle 26 with self-locking is used for reasons of strength. The proportional piston 27 can be exactly actuated by means of a monitoring device for the angle of rotation.

For the closing procedure, the motor 3 rotates the spindle 26 back, whereby the proportional piston 27 is moved back as well, which action will enlarge a compression chamber 25, which is disposed adjacent the proportional piston 27. The hydraulic oil from the pressure compartments or operating chambers 6 and 7 of the door operator 1 is pushed back into the pump 5 by means of the pressure building spring force accumulator 4.

FIG. 1 reveals furthermore, that the inventive door operator 1 is provided with a fire-protection/releasing device 28, which in the exemplary case is formed as a solenoid valve. In the exemplary case, the releasing device 28 is disposed in the second hydraulic line 23 between the pressure compartment 6 and a reservoir chamber 29, which is unpressurized and in which the drive unit 2 is disposed in the illustrated embodiment. However, any other unpressurized reservoir chamber of the housing 13 of the door operator 1 is suitable.

### LIST OF REFERENCES

1 door operator
2 drive unit
3 motor
4 spring force accumulator
5 hydraulic pump
6 pressure compartment (drive unit)
7 pressure compartment (spring force accumulator)
8 cam disc
9 output shaft
10 force transmission rollers
11 force transmission rollers
12 compression spring
13 housing
14 end
15 housing wall
16 end
17 spring loading piston
18 opening piston
19 damping piston
20 compartment
21 separating wall
22 first hydraulic line
23 second hydraulic line
24 piston rod
25 compression chamber
26 spindle
27 proportional piston
28 releasing device
29 reservoir chamber

1.-13. (canceled)

14. A door operator comprising:
a housing defining a first pressure compartment, a second pressure compartment and an unpressurized reservoir chamber;
a drive unit disposed in the housing and having an output shaft coupleable to a door, the drive unit being associated with the first pressure compartment;
a hydraulic pump in hydraulic connection with the first and second pressure compartments;
a motor in driving connection with the hydraulic pump;
a spring force accumulator disposed in the housing, the spring force accumulator being associated with the second pressure compartment and coupled to the drive unit and the motor;
a hydraulic circuit connecting at least one of the first and second pressure compartments with the hydraulic pump; and
a fire-protection/releasing device disposed between the hydraulic circuit and the unpressurized reservoir chamber.

15. The door operator of claim 14, wherein the drive unit comprises a cam drive comprising a cam disc mounted on the output shaft and first and second force transmission rollers disposed on two sides of the output shaft and bearing on cam paths of the cam disc.

16. The door operator of claim 15, wherein the spring force accumulator comprises a spring loading piston and a compression spring, the compression spring having a first end bearing against a housing wall of the hydraulic pump, and a second end bearing against the spring loading piston.

17. The door operator of claim 16, wherein the second pressure compartment is disposed adjacent to the spring loading piston.

18. The door operator of claim 16, wherein the drive unit further comprises an opening piston which carries the first force transmission roller, the spring loading piston being coupled to the opening piston.

19. The door operator of claim 15, further comprising a damping piston which carries the second force transmission roller, the first pressure compartment being disposed adjacent to the damping piston.

20. The door operator of claim 14, wherein the housing has a reception compartment for accommodating the drive unit, and a fluid-tight separating wall, the second pressure compartment being separated from the reception compartment by the fluid-tight separating wall.

21. The door operator of claim 14, wherein the motor comprises one of an alternating current micro-motor and a direct current micro-motor.

22. The door operator of claim 14, wherein the hydraulic pump comprises a proportional piston pump.

23. The door operator of claim 22, wherein the proportional piston pump comprises a spindle rotatably driven by the motor, and a translationally movable proportional piston cooperating with the spindle.

24. The door operator of claim 23, wherein the proportional piston pump has a compression chamber which is in hydraulic connection with the second pressure compartment by a first hydraulic line of the hydraulic circuit and in hydraulic connection with the first pressure compartment by a second hydraulic line of the hydraulic circuit, the proportional piston being disposed adjacent to the compression chamber.

25. The door operator of claim 14, wherein the fire-protection/releasing device comprises a solenoid valve.

26. The door operator of claim 20, wherein the housing further has an intermediate compartment which is disposed adjacent to the second pressure compartment, the door operator further comprising a hydraulic damping device disposed between the reception compartment and the intermediate compartment.

27. The door operator of claim 14, wherein the first and second pressure compartments are connected in series.

28. The door operator of claim 14, wherein the door operator is a swing door operator.
